(19) United States
(12) Patent Application Publication
(10) Pub. No.: US 2022/0197484 A1
(43) Pub. Date: Jun. 23, 2022

(54) TECHNOLOGIES FOR TRANSFORMING A DATA DISPLAY

(71) Applicant: Genesys Telecommunications Laboratories, Inc., Daly City, CA (US)

(72) Inventors: Christian T. Neuberger, JR., Durham, NC (US); Anuphinh P. Wanderski, Daly City, CA (US)

(21) Appl. No.: 17/129,129

(22) Filed: Dec. 21, 2020

(51) Int. Cl. G06F 3/0484; G06T 11/20; G06F 9/451; G06F 16/26

(52) U.S. Cl. CPC G06F 3/04845; G06T 11/206; G06Q 10/06398; G06F 16/26; G06T 2200/24; G06F 9/451

(57) ABSTRACT

A method for transforming a first data display into a second data display according to one embodiment includes presenting the first data display on a graphical user interface element of a user device; modifying the graphical user interface element of the user device in response to receiving a user input; analyzing data display criteria comprising at least one of user device parameters, administrator parameters, user parameters, and data parameters; transforming the first data display into the second data display based on the data display criteria and the modified graphical user interface element of the user device, wherein the first data display is different from the second data display; and presenting the second data display on the modified graphical user interface element of the user device.

### BACKGROUND

Current enterprise reporting software may display data as data visualizations, including, for example, tables, charts, graphs, etc. Data visualizations may require users to view data on a large display (e.g., a monitor/screen) to interpret the data. Alternatively, a data analyst may be required to manipulate the data into a summary report for the user. Although one of the most common ways to present data may be in the form of visualizations, users may often utilize varying screen sizes on devices. For example, the use of mobile devices has increased since the introduction of smart phones. Partnering software enterprises may often embed services within each other's graphical user interfaces (e.g., in the form of an application), which may result in the need for smaller presentation of data.

Current technologies may be available to assist with screen size and data display; however, such technologies may not reformat the display of data without assistance from an administrator. Responsive web design may be used to render data to fit a screen size and device. For responsive web design to function effectively, an administrator may need to instruct a system to adjust the web page content based on a variety of criteria. While responsive web design may eliminate content or adjust content to fit a screen's size, it may not drastically change the display of the content to fit the context of the user. For example, a full web page on a desktop monitor screen may display 4 columns of content. On a mobile phone, the web page may be reorganized such that the 4 columns become 1 column of content. In other words, when switching from a large screen to a small screen, current technologies may rearrange a data visualization to fit the small screen; however, some structures of the original data visualization may be replaced with ellipses, be truncated, have labels removed, not fit on the small screen, etc.

### SUMMARY

According to an embodiment, a method for transforming a first data display into a second data display may include presenting the first data display on a graphical user interface element of a user device; modifying the graphical user interface element of the user device in response to receiving a user input; analyzing data display criteria comprising at least one of user device parameters, administrator parameters, user parameters, and data parameters; transforming the first data display into the second data display based on the data display criteria and the modified graphical user interface element of the user device, wherein the first data display is different from the second data display; and presenting the second data display on the modified graphical user interface element of the user device.

In some embodiments, modifying the graphical user interface element of the user device may include at least one of minimizing, maximizing, restoring, and resizing the graphical user interface element.

In some embodiments, the user device parameters may include at least one of a user device type, a user device size, a user device screen resolution, a user device screen size, a graphical user interface element size, a web-based application type, an external device type, and an external device size.

In some embodiments, the administrator parameters may include ranked data or tagged data.

In some embodiments, the user parameters may include at least one of a user profile information, a user location, and a user language.

In some embodiments, the data parameters may include a data type or a data size.

In some embodiments, each of the first data display and the second data display may include at least one of a visualization, a number, and natural language.

In some embodiments, the first data display may include a visualization.

In some embodiments, the second data display may include a natural language.

In some embodiments, the visualization may be a data table and the natural language may be a natural language text summarizing the data in the data table.

According to another embodiment, a method for transforming a first data display into a second data display may include presenting the first data display on a first user device; analyzing data display criteria at a second user device, wherein the data display criteria may include at least one of first user device parameters, second user device parameters, administrator parameters, user parameters, and data parameters; transforming the first data display into the second data display based on the data display criteria, wherein the first data display is different from the second data display; and presenting the second data display on the second user device.

In some embodiments, the first user device parameters may include at least one of a first user device type, a first user device size, a first user device screen resolution, a first user device screen size, a first user device graphical user interface element size, a first web-based application type, an external device type, and an external device size; the second user device parameters may include at least one of a second user device type, a second user device size, a second user device screen resolution, a second user device screen size, a second user device graphical user interface element size, a second web-based application type, an external device type, and an external device size; the administrator parameters may include ranked data or tagged data; and the user parameters may include at least one of a user profile information, a user location, and a user language.

In some embodiments, each of the first data display and the second data display may include at least one of a visualization, a number, and natural language.

According to another embodiment, a system for transforming a first data display into a second data display may include at least one processor; and at least one memory comprising a plurality of instructions stored thereon that, in response to execution by the at least one processor, causes the system to: present the first data display on a graphical user interface element of a user device; modify the graphical user interface element of the user device in response to receiving a user input; analyze data display criteria comprising at least one of user device parameters, administrator parameters, and user parameters; transform the first data display into the second data display based on the data display criteria and the modified graphical user interface element of the user device, wherein the first data display is different from the second data display; and present the second data display on the modified graphical user interface element of the user device.

In some embodiments, modifying the graphical user interface element may include at least one of minimizing, maximizing, restoring, and resizing the graphical user interface element.

In some embodiments, the user device parameters may include at least one of a user device type, a user device size, a user device screen resolution, a user device screen size, a graphical user interface element size, a first web-based application type, an external device type, and an external device size.

In some embodiments, each of the first data display and the second data display may include at least one of a visualization, a number, and natural language.

In some embodiments, the first data display may include a visualization.

In some embodiments, the second data display may include a natural language.

In some embodiments, the visualization may be a data table and the natural language may be natural language text summarizing the data in the data table.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a simplified block diagram of at least one embodiment of a system for transforming a data display;

FIG. 2 is a simplified block diagram of at least one embodiment of a computing system;

FIG. 3 is a simplified flow diagram of at least one embodiment of a method for transforming a data display using the system of FIG. 1;

FIG. 4 is a simplified flow diagram of at least one embodiment of a method for transforming a data display using the system of FIG. 1; and

FIGS. 5-8 illustrate various states of at least one embodiment of a graphical user interface of an application executed by the system of FIG. 1.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

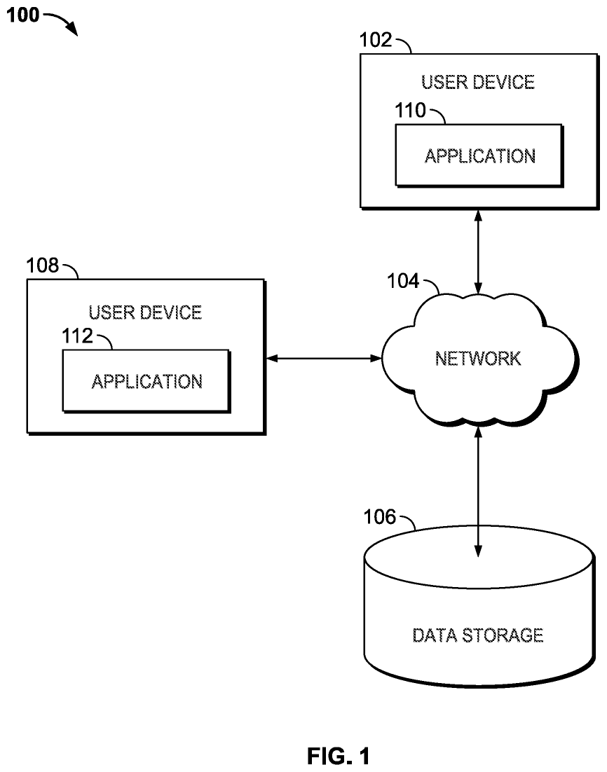

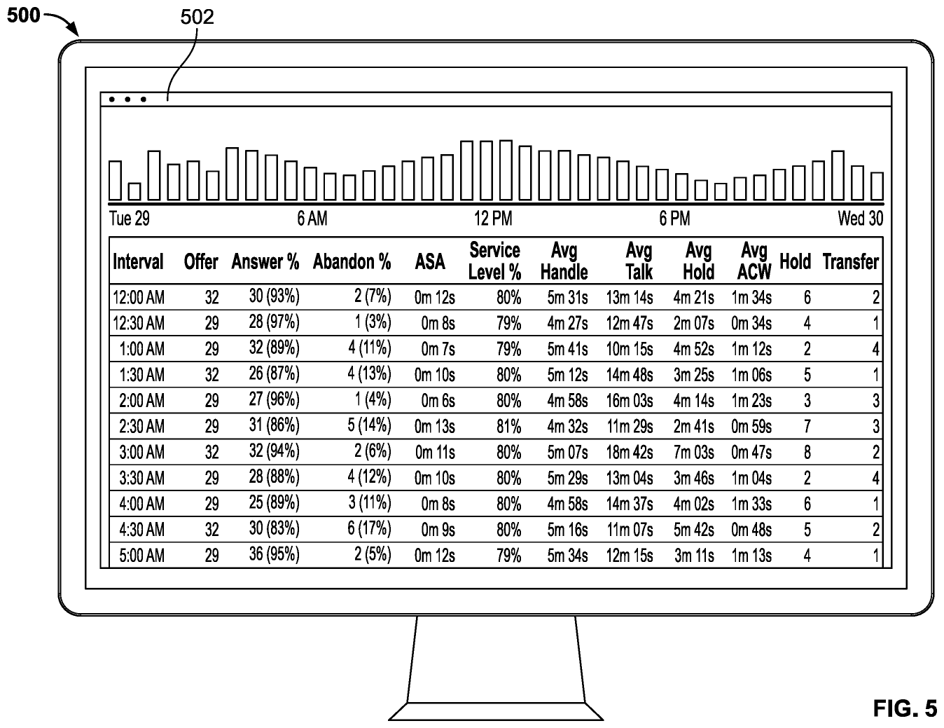

Referring now to FIG. 1, in the illustrative embodiment, a system 100 for transforming a data display includes a user device 102, a network 104, a data storage 106, and a user device 108. It should be appreciated that references to the user device 102 or the user device 108 herein may be made for clarity of the description and may be intended to be for illustrative purposes only. Accordingly, in some embodiments, such references to the user device 102 may be alternatively made with respect to the user device 108 without loss of generality. Although only one user device 102, one network 104, one data storage 106, and one user device 108 are shown in the illustrative embodiment of FIG. 1, the system 100 may include multiple user devices 102, networks 104, data storages 106, and/or user devices 108 in other embodiments. For example, as described herein, multiple user devices 102, 108 may be used to access, for example, a web-based graphical user interface (e.g., the graphical user interface 500 of FIGS. 5-8) that permits users to view data in the form of a data display.

It should be appreciated that the system 100 and technologies described herein may interpret and redraw (or transform) an original display of data (e.g., a visualization such as a table) presented on a device and/or a screen into a different display of data (e.g., natural language or numbers) when fitting the different display of data on a different device and/or a modified (e.g., smaller) screen size by using particular criteria. The interpreting and redrawing/transforming of a display of data may include the technologies described herein automatically changing the display of data based on a change of device and/or a resizing of a screen. An advantage of the technologies described herein according to an embodiment may be that the system 100 analyzes particular criteria and redraws/transforms the original display of data into a different display of data rather than attempting to fit the same elements of the original display of data from a device and/or screen into a different device and/or modified screen size. The particular criteria may include movement of a device, screen size, most used data columns in a data table, and/or most searched for data columns in a data table. Artificial intelligence may be utilized to interpret a visualization (e.g., data table) and display the data in the form of numbers and/or natural language to fit a particular device and/or screen size. The technologies described herein address the issue of varying screen sizes and dense data presentation by delivering data and reports to users across multiple screen sizes, devices, and applications. As an example, at a full desktop computer screen size, a user may see detailed consensus data for the United States in the form of a table. If the same data is presented on a small screen size, the technologies described herein may interpret the data and redraw/transform the data table into a visualization, natural language (e.g., a summary article of the data table), or numbers that best meet the need of the user.

It should be appreciated that each of the user device 102, network 104, data storage 106, and user device 108 may be embodied as any type of device/system or collection of devices/systems suitable for performing the functions described herein. More specifically, in the illustrative embodiment, the user device 102 and/or the user device 108 may be a voice communications device, such as a telephone, a cellular phone, or a satellite phone. The user device 102 and/or the user device 108 alternatively may be, for example, an electronic tablet, an electronic book reader, a personal digital assistant (PDA), a portable music player, or a computer capable of communication with the data storage 106. The user device 102 and/or the user device 108 may have various input/output devices with which a user may interact to provide and receive audio, text, video, and/or other forms of data. The user device 102 and/or the user device 108 may allow a user to interact with the data storage 106 over the network 104 as described herein.

In some embodiments, the user device 102 and/or the user device 108 may be embodied as any type of device capable of executing an application and otherwise performing the functions described herein. For example, in the illustrative embodiment, the user device 102 may be configured to execute an application 110, and the user device 108 may be configured to execute an application 112. It should be appreciated that the applications 110, 112 may be embodied as any type of application suitable for performing the functions described herein. In particular, in some embodiments, the applications 110, 112 may be embodied as a mobile application (e.g., a smartphone application), a cloud-based application, a web application, a thin-client application, and/or another type of application. For example, in some embodiments, one or more of the applications 110, 112 may serve as a client-side interface (e.g., via a web browser) for a web-based application or service. Additionally, although only one application 110, 112 is shown as being executed by the corresponding devices 102, 108, it should be appreciated that each of the devices 102, 108 may be configured to execute other applications in order to perform the functions described herein. As described herein, in some embodiments, a user may interact with the user devices 102, 108 via a graphical user interface (GUI) of the applications 110, 112 (e.g., the graphical user interface 500 of FIGS. 5-8) in order to view data in the form of a data display as described herein.

The network 104 may be embodied as any one or more types of communication networks that are capable of facilitating communication between the various devices communicatively connected via the network 104. As such, the network 104 may include one or more networks, routers, switches, access points, hubs, computers, and/or other intervening network devices. For example, the network 104 may be embodied as or otherwise include one or more cellular networks, telephone networks, local or wide area networks, publicly available global networks (e.g., the Internet), ad hoc networks, short-range communication links, or a combination thereof In some embodiments, the network 104 may include a circuit-switched voice or data network, a packet-switched voice or data network, and/or any other network able to carry voice and/or data. In particular, in some embodiments, the network 104 may include Internet Protocol (IP)-based and/or asynchronous transfer mode (ATM)-based networks. In some embodiments, the network 104 may handle voice traffic (e.g., via a Voice over IP (VOIP) network), web traffic (e.g., such as hypertext transfer protocol (HTTP) traffic and hypertext markup language (HTML) traffic), and/or other network traffic depending on the particular embodiment and/or devices of the system 100 in communication with one another. In various embodiments, the network 104 may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. The network 104 may enable connections between the various devices/systems 102, 106, 108 of the system 100. It should be appreciated that the various devices/systems 102, 106, 108 may communicate with one another via different networks 104 depending on the source and/or destination devices 102, 106, 108. Further, in some embodiments, one or more of the devices/systems 102, 106, 108 may not be configured to communicate with another of the devices/systems 102, 106, 108 via the network 104.

The data storage 106 may be embodied as one or more databases, data structures, and/or data storage devices capable of storing data or otherwise facilitating the storage of such data. For example, in some embodiments, the data storage 106 may include one or more cloud storage buckets. The data storage 106 may also be embodied as any device or component, or collection of devices or components, capable of short-term or long-term storage of data. Although the data storage 106 is described herein as data storages and databases, it should be appreciated that the data storage 106 may include both a database (or other type of organized collection of data and structures) and data storage for the actual storage of the underlying data. The data storage 106 may store various data useful for performing the functions described herein.

In the illustrative embodiment, the network 104 and/or the data storage 106 (and/or one or more portions thereof) may be embodied as a cloud-based system executing in a cloud computing environment; however, it should be appreciated that, in other embodiments, the network 104 and/or the data storage 106 (and/or one or more portions thereof) may be embodied as one or more systems executing outside of a cloud computing environment. In cloud-based embodiments, the network 104 and/or the data storage 106 (and/or one or more portions thereof) may be embodied as a server-ambiguous computing solution, for example, that executes a plurality of instructions on-demand, contains logic to execute instructions only when prompted by a particular activity/trigger, and does not consume computing resources (or consumes nominal resources) when not in use. That is, the network 104 and/or the data storage 106 (and/or one or more portions thereof) may be embodied as a virtual computing environment residing “on” a computing system (e.g., a distributed network of devices) in which various 3^{rd} party virtual functions may be executed corresponding with the functions of the network 104 and/or the data storage 106 (and/or one or more portions thereof) described herein. For example, when an event occurs (e.g., data is transferred to the network 104 for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the network 104), the appropriate virtual function(s) may be executed to perform the actions before eliminating the instance of the virtual function(s).

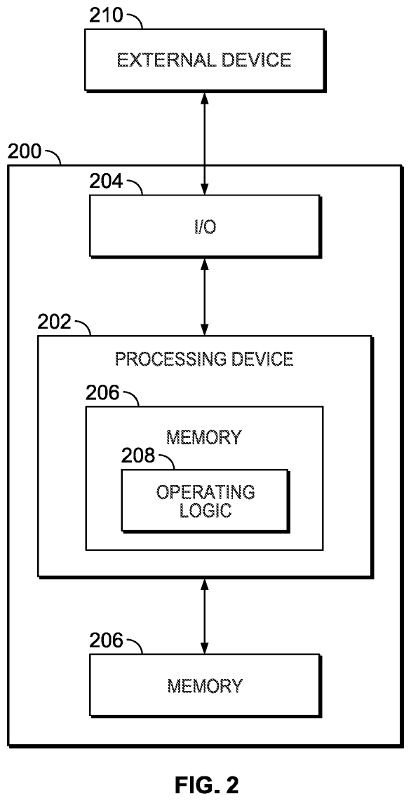

It should be appreciated that each of the user device 102, network 104, data storage 106, and user device 108 may be embodied as (or include) one or more computing devices similar to the computing device 200 described below in reference to FIG. 2. For example, in the illustrative embodiment, each of the user device 102, network 104, data storage 106, and user device 108 may include a processing device 202 and a memory 206 having stored thereon operating logic 208 (e.g., a plurality of instructions) for execution by the processing device 202 for operation of the corresponding device.

Referring now to FIG. 2, a simplified block diagram of at least one embodiment of a computing device 200 is shown. The illustrative computing device 200 depicts at least one embodiment of a user device, a network, a data storage, and/or another user device that may be utilized in connection with the user device 102, the network 104, the data storage 106, and/or the user device 108 illustrated in FIG. 1. Depending on the particular embodiment, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, FireWire, CAT 5, or any other type of communication port or interface), and/or other communication circuitry. Communication circuitry of the computing device 200 may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as the user device 102, the network 104, the data storage 106, and/or the user device 108. Further, in some embodiments, the external device 210 may be embodied as another computing device, switch, diagnostic tool, controller, printer, display, alarm, peripheral device (e.g., keyboard, mouse, monitor/display, touch screen display, speakers, headphones, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is programmable and executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable type, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

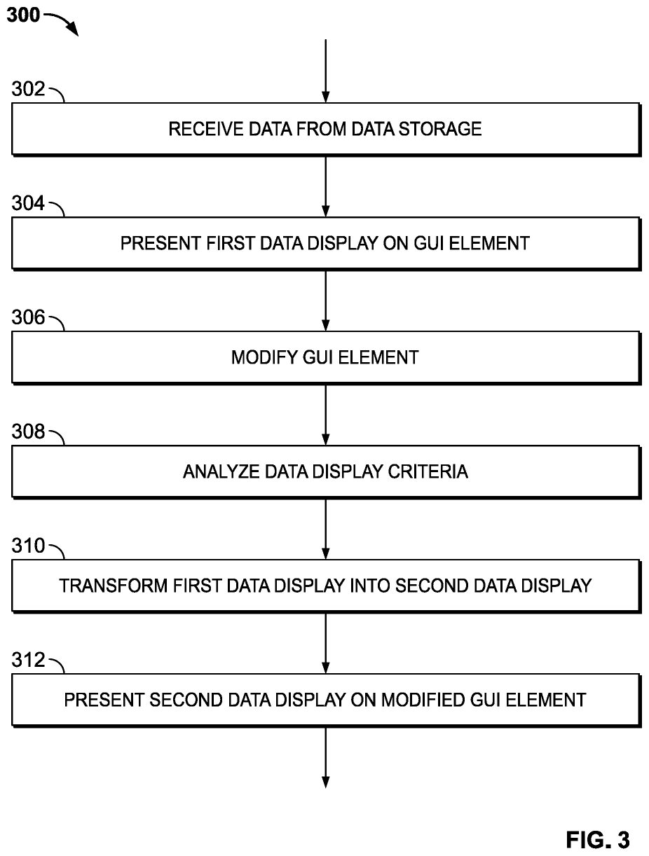

Referring now to FIG. 3, in use, the system 100 may execute a method 300 for transforming a data display. A data display may be a visual presentation of data/information. In some embodiments, a data display may be at least one of a visualization, a number, or natural language. A visualization may be used to communicate data/information to a user. In some embodiments, a visualization may be at least one of a chart, a table, a graph, a map, an infographic, and a dashboard. In some embodiments, a visualization may be at least one of an area chart, a bar chart, a box-and-whisker plot, a bubble cloud, a bullet graph, a cartogram, a circle view, a dot distribution map, a Gantt chart, a heat map, a highlight table, a histogram, a matrix, a network, a polar area, a radial tree, a scatter plot (e.g., a 2D or 3D scatter plot), a streamgraph, a text table, a line graph, and a pie chart. A number (or numeral) may be an arithmetical value, expressed by a word or symbol, representing a particular quantity or amount. Natural language may be language that has developed naturally through use as distinguished from constructed or formal languages such as those languages used to program computers or study logic. In some embodiments, the natural language may be a word or a string of words (i.e., a sentence).

It should be appreciated that the particular blocks of the method 300 are illustrated by way of example, and such blocks may be combined or divided, added or removed, and/or reordered in whole or in part depending on the particular embodiment, unless stated to the contrary. Prior to execution of the method 300, it should be appreciated that a user may interact with the user device 102 via a user interface of the application 110 (e.g., a graphical user interface) in order to communicate a request for data to a data storage (e.g., the system 100, via the data storage 106, may receive a request for data). In some embodiments, the request for data may be generated by the user device 102 utilizing at least one of an email, a chat, a website search, or a voice. For example, a user may communicate a request regarding her job performance data to a data storage (e.g., the data storage 106) via a graphical user interface (e.g., the application 110) of a desktop computer (e.g., the user device 102). In some embodiments, the user's job performance data may be at least one of a work schedule, a time worked, and an employment goal.

The illustrative method 300 may begin with block 302 in which the system 100 (e.g., via the data storage 106) may receive the request for data from the user device 102 (e.g., via the application 110) via the network 104. The system 100 (e.g., via the data storage 106) may transmit the requested data to the user device 102 (e.g., via the application 110) via the network 104. For example, the data storage (e.g., the data storage 106) may transmit the user's job performance data to the desktop computer (e.g., the user device 102) via a network (e.g., the network 104).

In block 304, the system 100 (e.g., via the user device 102) may generate a first data display using the requested data received from the data storage 106. In some embodiments, the first data display may be at least one of a visualization, a number, or natural language. The user device 102 may present/display the first data display on a graphical user interface element of the user device 102. The user device 102 may include a display (e.g., a monitor/screen) that presents/displays the graphical user interface element. A graphical user interface element may be at least one of a window, a menu, an icon, a control, and a tab. A window (or view pane) may be an area on the screen of the user device 102 that displays data such that the contents of the window are displayed independently from the remainder of the screen. For example, the desktop computer (e.g., the user device 102) may present/display the user's job performance data in the form of a multi-column table visualization (e.g., a first data display) in a web page browser window (e.g., a graphical user interface element) via a screen. In some embodiments, a user may use a graphical user interface such as the graphical user interface 500 of FIG. 5 to view data in the form of a multi-column table (e.g., a data display as a visualization) in a web page browser window on a desktop computer (e.g., the user device 102). A menu may allow the user to execute commands by selecting from a list of choices. An icon may be a picture that represents objects such as a file, a program, a web page, or a command. A control may allow a user to interact with a computing device through direct manipulation to read or edit information regarding an application. Common uses for controls may involve the display of collections of related items (such as with various list and canvas controls), initiation of actions and processes within the graphical user interface (buttons and menus), navigation within the space of the information system (links, tabs and scrollbars), and representing and manipulating data values (such as labels, check boxes, radio buttons, sliders, and spinners). A tab may be a box on the graphical user interface that contains a text label or graphical icon associated with a window.

In block 306, the system 100 (e.g., via the user device 102) may modify the graphical user interface element. In some embodiments, the modifying may be in response to receiving a user input. In some embodiments, the system 100 (e.g., via the user device 102) may modify the graphical user interface element on a screen of the user device 102 by minimizing, maximizing, restoring (i.e., restoring down), or resizing the graphical user interface element. For example, the desktop computer (e.g., the user device 102) may minimize (restore down) the web page browser window (e.g., a graphical user interface element) on a screen of the desktop computer (e.g., the user device 102). In some embodiments, the user device 102 may modify the graphical user interface element by moving the graphical user interface element on a screen of the user device 102.

In block 308, the system 100 may analyze data display criteria. In some embodiments, the data display criteria may be at least one of user device parameters, administrator parameters, user parameters, and data parameters. The user device parameters may be at least one of a user device type, a user device size, a user device screen resolution, a user device screen size, a graphical user interface element size, a web-based application type, an external device type, or an external device size. In some embodiments, the system 100 may access the operating logic (e.g., an operating system) of the user device 102 to determine one or more user device parameters. In some embodiments, the external device type may be at least one of a speaker, a headphone, or a monitor.

The administrator parameters may be ranked data or tagged data. An administrator may rank or tag data based on the data that the administrator may determine to be relevant and/or critical to the administrator and/or the user. In some embodiments, an administrator may rank or tag data based on a particular standard that may determine the importance of the data to the administrator and/or the user. For example, the data storage (e.g., the data storage 106) may include 20 years of the user's job performance data, and the administrator may rank or tag the user's job performance data from only the past month. The administrator may determine that only the past month of data may be more pertinent to the administrator and/or the user. Similarly, for example, if a user may be close to achieving a job performance goal, the administrator may rank or tag data that is pertinent to the user achieving that job performance goal.

The user parameters may be at least one of a user profile information, a user location, a user language, a user disability (or ability), a user ethnicity, a user gender, a user age (e.g., young or elderly user), a user dialect, a user slang, and a user diction. The data parameters may be a data type or a data size. For example, the system 100 may analyze that the user may speak the English language (e.g., a user language), the job performance data may include 5 MB of data (e.g., data size), the past year of data may be tagged as important (e.g., administrator parameter), and the desktop computer monitor screen may be 20 inches (e.g., user device screen size).

In block 310, the system 100 may automatically transform the first data display into a second data display utilizing the data display criteria. The first data display may be different from the second data display. In some embodiments, the second data display may be at least one of a visualization, a number, or natural language. For example, the system 100 may transform the user's job performance data in the form of a multi-column table visualization (e.g., a first data display) into numbers (e.g., a second data display). The system 100 may use the power of artificial intelligence (AI) and machine learning (ML) techniques to train and develop an AI model to analyze the data display criteria and transform the first data display into the second data display. In some of the embodiments described herein, the system 100 (e.g., one or more of the devices/systems thereof) may leverage one or more machine learning techniques to perform the functions described herein. In doing so, in some embodiments, the system 100 (e.g., one or more of the devices/system thereof) may utilize one or more neural network algorithms, regression algorithms, instance-based algorithms, regularization algorithms, decision tree algorithms, Bayesian algorithms, clustering algorithms, association rule learning algorithms, deep learning algorithms, dimensionality reduction algorithms, rule-based algorithms, ensemble algorithms, artificial intelligence, and/or other suitable machine learning algorithms, techniques, and/or mechanisms. It should be appreciated that a supervised learning process may be incorporated into the method 300, which may improve the method 300 and the system 100. In some embodiments, the system 100 may use manual comments/feedback from an administrator and/or a user to retrain an AI model.

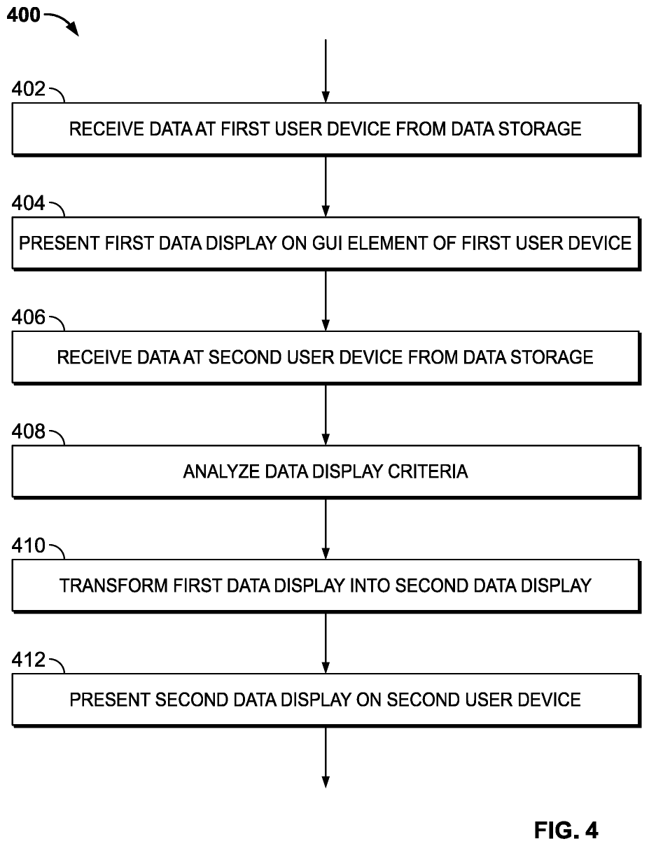

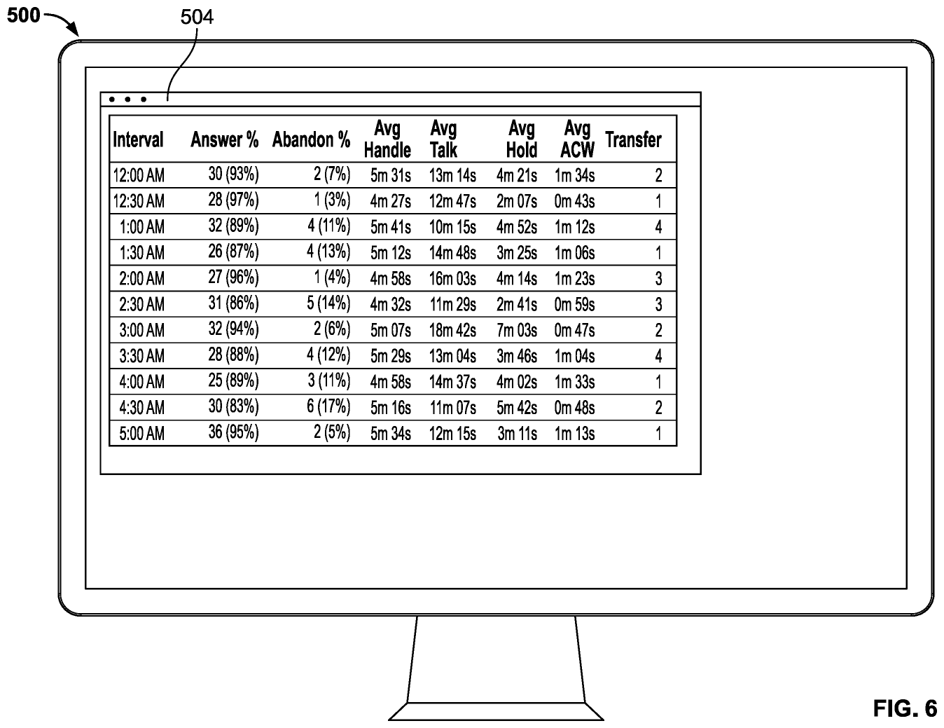

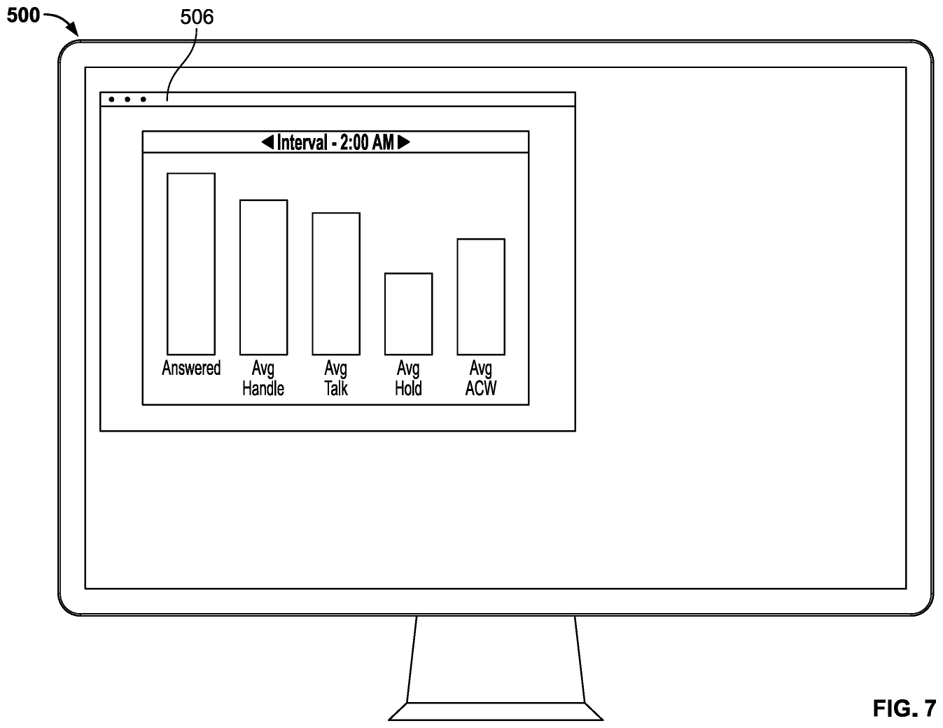

In block 312, the system 100 (e.g., via the user device 102) may present the second data display on the modified graphical user interface element of block 306. For example, the desktop computer (e.g., the user device 102) may present/display the user's job performance data in the form of numbers (e.g., a second data display) in a minimized (or restored/not maximized) web page browser window (e.g., a graphical user interface element) via a screen. In some embodiments, a user may use a graphical user interface such as the graphical user interface 500 of FIG. 6 to resize (e.g., minimize (or restore/not maximize)) the web page browser window having the multi-column table illustrated in FIG. 5 to view the data in the form of a smaller table in a smaller web page browser window on a desktop computer (e.g., the user device 102). In some embodiments, a user may use a graphical user interface such as the graphical user interface 500 of FIG. 7 to resize (e.g., minimize (or restore/not maximize)) the web page browser window having the multi-column table illustrated in FIG. 5 to view the data in the form of a bar graph in a smaller web page browser window on a desktop computer (e.g., the user device 102). It should be appreciated that the system 100 may execute the method 400 of FIG. 4 (or a portion thereof) as described in detail below in association with the method 300 of FIG. 3.

As an example, when a user is utilizing a maximized window (e.g., a graphical user interface element) on a desktop computer monitor screen (e.g., the user device 102), job performance data illustrating an average performance score of 7 out of 10 may be presented in multi-column table (e.g., a first data display). When the user minimizes (or restores) the window, the system 100 may transform the multi-column table into one or more natural language sentences (e.g., a second data display) stating: “Your average performance score is 7 out of 10. Therefore, your goals need to be adjusted from quantity of hours worked to quality of hours worked.” Generally, the user would need to evaluate the job performance data presented in the multi-column table to find a conclusion regarding the data. However, the system 100 may evaluate the data in the multi-column table shown in the maximized window to determine which aspects of the data are important to the user and may transform the multi-column table into the natural language sentences shown in the minimized (or restored) window to provide a summary/conclusion regarding the data to the user. In other words, the system 100 may use the data display criteria to make a determination as to which aspects of the job performance data are important to the user.

Although the blocks 302-312 are described in a relatively serial manner, it should be appreciated that various blocks of the method 300 may be performed in parallel in some embodiments.

Referring now to FIG. 4, in use, the system 100 may execute a method 400 for transforming a data display. It should be appreciated that the particular blocks of the method 400 are illustrated by way of example, and such blocks may be combined or divided, added or removed, and/or reordered in whole or in part depending on the particular embodiment, unless stated to the contrary. Prior to execution of the method 400, it should be appreciated that a user may interact with the user device 102 via a user interface of the application 110 (e.g., a graphical user interface) in order to communicate a request for data to a data storage (e.g., the system 100, via the data storage 106, may receive a request for data). In some embodiments, the request for data may be generated by the user device 102 utilizing at least one of an email, a chat, a website search, or a voice. For example, a user may communicate a request regarding her job performance data to a data storage (e.g., the data storage 106) via a graphical user interface (e.g., the application 110) of a desktop computer (e.g., the user device 102). In some embodiments, the user's job performance data may be at least one of a work schedule, a time worked, and an employment goal.

The illustrative method 400 may begin with block 402 in which the system 100 (e.g., via the data storage 106) may receive the request for data from the user device 102 (e.g., via the application 110) via the network 104. The system 100 (e.g., via the data storage 106) may transmit the requested data to the user device 102 (e.g., via the application 110) via the network 104. For example, the data storage (e.g., the data storage 106) may transmit the user's job performance data to the desktop computer (e.g., the user device 102) via a network (e.g., the network 104).

In block 404, the system 100 (e.g., via the user device 102) may generate a first data display using the requested data received from the data storage 106. In some embodiments, the first data display may be at least one of a visualization, a number, or natural language. The user device 102 may present/display the first data display on a graphical user interface element of the user device 102. The user device 102 may include a display (e.g., a monitor/screen) that presents/displays the graphical user interface element. For example, the desktop computer (e.g., the user device 102) may present/display the user's job performance data in the form of a multi-column table visualization (e.g., a first data display) in a web page browser window (e.g., a graphical user interface element) via a screen. In some embodiments, a user may use a graphical user interface such as the graphical user interface 500 of FIG. 5 to view data in the form of a multi-column table (e.g., a data display as a visualization) in a web page browser window on a desktop computer (e.g., the user device 102).

In block 406, the system 100 (e.g., via the data storage 106) may receive a request for data from the user device 108 (e.g., via the application 112) via the network 104. Although not shown, it should be appreciated that a user may interact with the user device 108 via a user interface of the application 112 (e.g., a graphical user interface) in order to communicate a request for data to a data storage (e.g., the system 100, via the data storage 106, may receive a request for data). In some embodiments, the request for data may be generated by the user device 108 utilizing at least one of an email, a chat, a website search, or a voice. For example, a user may communicate a request regarding her job performance data to a data storage (e.g., the data storage 106) via a graphical user interface (e.g., the application 112) of a mobile computing device such as a mobile phone (e.g., the user device 108). The system 100 (e.g., via the data storage 106) may transmit the requested data to the user device 108 (e.g., via the application 112) via the network 104. For example, the data storage (e.g., the data storage 106) may transmit the user's job performance data to the mobile phone (e.g., the user device 108) via a network (e.g., the network 104).

In block 408, the system 100 may analyze data display criteria. In some embodiments, the data display criteria may be at least one of first user device parameters, second user device parameters, administrator parameters, user parameters, and data parameters. The first user device parameters may be at least one of a first user device type, a first user device size, a first user device screen resolution, a first user device screen size, a first user device graphical user interface element size, a first web-based application type, an external device type, or an external device size. The second user device parameters may be at least one of a second user device type, a second user device size, a second user device screen resolution, a second user device screen size, a second user device graphical user interface element size, a second web-based application type, an external device type, or an external device size. In some embodiments, the system 100 may access the operating logic (e.g., an operating system) of the user device 102 to determine the first user device parameters. In some embodiments, the system 100 may access the operating logic of the user device 108 to determine the second user device parameters. For example, the system 100 may analyze that the user may first be using the desktop computer (e.g., the user device 102), the user may then be using the mobile phone (e.g., the user device 108), the user may speak the English language (e.g., a user language), and the job performance data may include 5 MB of data (e.g., data size).

In block 410, the system 100 may automatically transform the first data display into a second data display utilizing the data display criteria. The first data display may be different from the second data display. In some embodiments, the second data display may be at least one of a visualization, a number, or natural language. For example, the system 100 may transform the user's job performance data in the form of a multi-column table visualization (e.g., a first data display) into numbers (e.g., a second data display). The system 100 may use AI and ML techniques to train and develop an AI model to analyze the data display criteria and transform the first data display into the second data display as described above in the method 300. It should be appreciated that a supervised learning process may be incorporated into the method 400, which may improve the method 400 and the system 100. In some embodiments, the system 100 may use manual comments/feedback from an administrator and/or a user to retrain an AI model similar to the method 300.

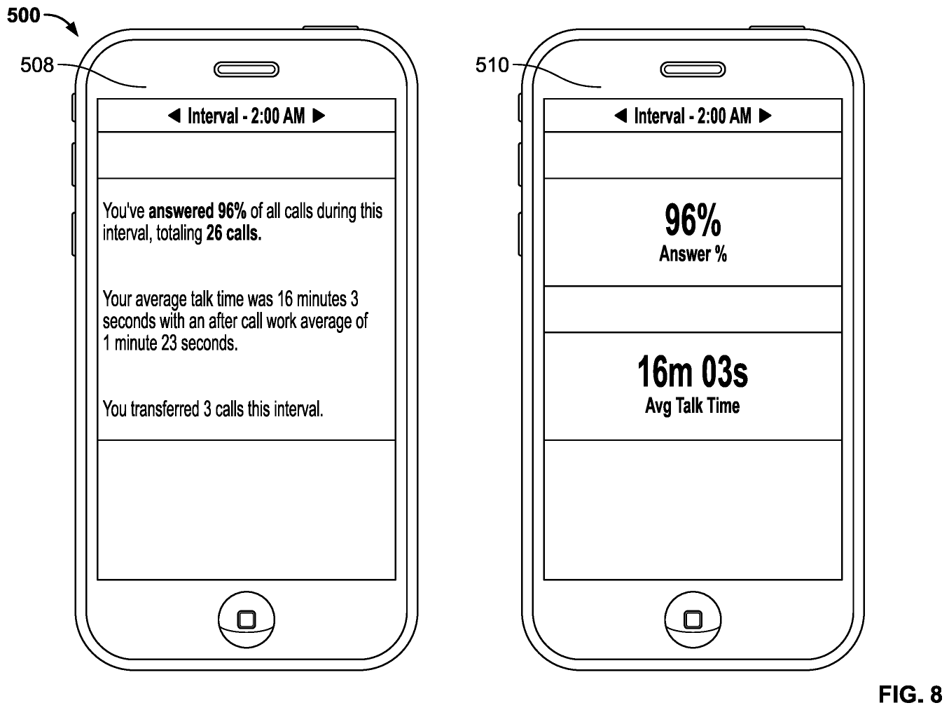

In block 412, the system 100 may present the second data display on the user device 108. In some embodiments, the second data display may be presented on a graphical user interface element of the user device 108. For example, the mobile phone (e.g., the user device 108) may present/display the user's job performance data in the form of numbers (e.g., a second data display) in a web-based application (e.g., the application 112) via a touch screen display. In some embodiments, a user may use a graphical user interface such as the graphical user interface 500 of FIG. 8 to utilize a web-based application (e.g., the application 112) on a mobile phone (e.g., the user device 108) to view data in the form of summary paragraphs (e.g., natural language) or numbers after being transformed from data in the form of a multi-column table (e.g., a data display as a visualization) in a web page browser window on a desktop computer (e.g., the user device 102) as illustrated in FIG. 5. It should be appreciated that the system 100 may execute the method 300 of FIG. 3 (or a portion thereof) as described in detail above in association with the method 400 of FIG. 4.

By way of example, when a user is utilizing a desktop computer monitor screen (e.g., the user device 102), job performance data illustrating an average performance score of 7 out of 10 may be presented in multi-column table (e.g., a first data display). When the user is utilizing a mobile phone (e.g., the user device 108), the system 100 may transform the multi-column table into one or more natural language sentences (e.g., a second data display) stating: “Your average performance score is 7 out of 10. Therefore, your goals need to be adjusted from quantity of hours worked to quality of hours worked.” As described above in method 300, the system 100 may use the data display criteria to make a determination as to which aspects of the job performance data are important to the user.

Although the blocks 402-412 are described in a relatively serial manner, it should be appreciated that various blocks of the method 400 may be performed in parallel in some embodiments.

FIGS. 5-8 illustrate various possible states of a graphical user interface 500 accessed by a user of a user device (e.g., the user devices 102, 108) to view data in the form of a data display.

As shown in FIG. 5, the illustrative graphical user interface 500 may display data in the form of a multi-column table (e.g., a data display as a visualization) in a web page browser window 502 on a desktop computer (e.g., the user device 102). The web page browser window 502 may encompass the entire screen (e.g., the window 502 may be maximized) of the desktop computer. For example, the system 100 (e.g., via the user device 102) may generate a first data display using requested data received from a data storage (e.g., the data storage106) (see block 304 of FIG. 3).

As shown in FIG. 6, the illustrative graphical user interface 500 may display data in the form of a smaller table (e.g., a data display as a visualization) in a web page browser window 504 on a desktop computer (e.g., the user device 102). The web page browser window 504 may encompass only a portion of the screen (e.g., the window 504 may be minimized (or restored/not maximized)). Certain data may be removed or condensed to a smaller width from the original multi-column table (e.g., the table in the window 502 of FIG. 5). Any removed data may be configured by an administrator. For example, the system 100 (e.g., via the user device 102) may present a second data display on a modified graphical user interface element (see blocks 306-312 of FIG. 3). In some embodiments, the system 100 may determine which type of data display to present to a user based on data about the user or the device the user is using, including, for example, data regarding user usage or skills.

As shown in FIG. 7, the illustrative graphical user interface 500 may display data in the form of a bar graph (e.g., a data display as a visualization) in a web page browser window 506 on a desktop computer (e.g., the user device 102). The web page browser window 506 may encompass only a portion of the screen (e.g., the window 506 may be minimized (or restored/not maximized)). A user may minimize (or restore/not maximize) the web page browser window 502 to view the data in the form of a bar graph in the web page browser window 506 on a desktop computer (e.g., the user device 102). The data may be displayed in a manner to inform the user of high level insights as the web page browser window 506 becomes smaller compared to the web page browser window 502 shown in FIG. 5. Similarly, a data display may be optimized based on device and user settings. For example, the system 100 (e.g., via the user device 102) may present a second data display on a modified graphical user interface element (see blocks 306-312 of FIG. 3).

As shown in FIG. 8, the illustrative graphical user interface 500 may display data in the form of summary paragraphs (e.g., natural language) in a touch screen display 508 or in the form of numbers and words in a touch screen display 510 in a web-based application (e.g., the application 112) on a mobile phone (e.g., the user device 108). The data may be displayed to provide the most relevant data to the user. For example, the system 100 may present the second data display on the user device 108 (see blocks 406-412 of FIG. 4).

1. A method for transforming a first data display into a second data display, the method comprising:
presenting the first data display on a graphical user interface element of a user device;
modifying the graphical user interface element of the user device in response to receiving a user input to resize the graphical user interface element;
analyzing data display criteria comprising at least one of user device parameters, administrator parameters;
transforming the first data display into the second data display based on the data display criteria and the modified graphical user interface element of the user device, wherein the first data display includes a first set of data elements and the second data display includes a second set of data elements different from the first set of data elements; and
presenting the second data display on the modified graphical user interface element of the user device.

2. (canceled)

3. The method of claim 1, wherein the user device parameters comprise at least one of a user device type, a user device size, a user device screen resolution, a user device screen size, a graphical user interface element size, a web-based application type, an external device type, and an external device size.

4. The method of claim 1, wherein the administrator parameters comprise ranked data that ranks an importance of one or more of the data elements of the first set of data elements.

5. The method of claim 1, wherein the user parameters comprise at least one of a user location and a user language.

6. The method of claim 1, wherein analyzing the data display criteria further comprises analyzing data parameters including a data type.

7. The method of claim 1, wherein each of the first data display and the second data display comprises at least one of a visualization, a number, and natural language.

8. The method of claim 7, wherein the first data display comprises a visualization.

9. The method of claim 8, wherein the second data display comprises a natural language.

10. The method of claim 9, wherein the visualization is a data table and the natural language is natural language text summarizing the data in the data table.

11-13. (canceled)

14. A system for transforming a first data display into a second data display, the system comprising:
at least one processor; and
at least one memory comprising a plurality of instructions stored thereon that, in response to execution by the at least one processor, causes the system to:
present the first data display on a graphical user interface element of a user device;
modify the graphical user interface element of the user device in response to receiving a user input to resize the graphical user interface element;
analyze data display criteria comprising at least one of user device parameters, administrator parameters, and user parameters;
transform the first data display into the second data display based on the data display criteria and the modified graphical user interface element of the user device, wherein the first data display includes a first set of data elements and the second data display includes a second set of data elements different from the first set of data elements; and
present the second data display on the modified graphical user interface element of the user device.

15. (canceled)

16. The system of claim 14, wherein the user device parameters comprise at least one of a user device type, a user device size, a user device screen resolution, a user device screen size, a graphical user interface element size, a first web-based application type, an external device type, and an external device size.

17. The system of claim 14, wherein each of the first data display and the second data display comprises at least one of a visualization, a number, and natural language.

18. The system of claim 17, wherein the first data display comprises a visualization.

19. The system of claim 18, wherein the second data display comprises a natural language.

20. (canceled)

21. The method of claim 1, wherein the second set of data elements comprises a natural language conclusion regarding the first set of data elements.

22. The method of claim 1, wherein transforming the first data display into the second data display comprises determining whether to represent the first set of data elements as one or more of a visualization, a number, and natural language in the second set of data elements based on the data display criteria and the modified graphical user interface element.

23. The method of claim 1, wherein the user parameters comprise a user disability.

24. The method of claim 1, wherein the user parameters comprise at least one of a user ethnicity, a user age, and a user gender.

25. The method of claim 1, wherein the user parameters comprise at least one of a user dialect, a user slang, and a user diction.

26. The method of claim 1, wherein transforming the first data display into the second data display comprises transforming the first data display into the second data display based on the data display criteria, the modified graphical user interface element, and an artificial intelligence model for the data display criteria.
